(19) United States
(12) Patent Application Publication
(10) Pub. No.: US 2011/0159725 A1
(43) Pub. Date: Jun. 30, 2011

(54) BRIDGING ADAPTER

(75) Inventor: Philip Curto, Astoria, NY (US)

(73) Assignee: CONSOLIDATED EDISON COMPANY OF NEW YORK, INC., New York, NY (US)

(21) Appl. No.: 12/648,407

(22) Filed: Dec. 29, 2009

(51) Int. Cl. H01R 33/945

(52) U.S. Cl. 439/517

(57) ABSTRACT

Apparatus for connecting an inoperable phase of electricity with an operable phase of electricity includes an electricity meter, a socket, and an electricity meter adapter having at least one first connector for a first phase of electricity and at least one second connector for a second phase of electricity, a bridging adapter connected between the at least one first connector for a first phase of electricity and the at least one second connector for a second phase of electricity thereby connecting together the first and second phases of electricity, wherein the electricity meter adapter is connected with the socket and the electricity meter is connected with the electricity meter adapter.

### BACKGROUND OF THE INVENTION

The present invention relates generally to a bridging adapter for an electrical meter, and more particularly to a bridging adapter that allows for a relatively simple way of connecting an inoperable electricity phase to an operable electricity phase in an electrical meter adapter device that connects with a common residential two-phase 110 volt electricity meter.

Residential customers of electricity are commonly supplied with two-phase electricity at approximately 110 volts alternating current (“AC”). A meter is typically used at the residence location or premises to measure the amount of electricity used by that residence. Oftentimes, one of the phases of electricity supplied becomes inoperable or “out of service” for various reasons, resulting in a partial “lights out” service condition for the customer. This condition may occur, for example, during winter months when a substance such as salt or other corrosive material contaminates and corrodes the underground service from the electrical distribution network to the customer's premises. Other common causes of this problem include collapsed ducts or other electricity network failures.

In response, typically the electricity provider sends a field technician to the customer's premises. The technician oftentimes installs a temporary jumper in the customer's end line electrical box or circuit breaker box or service panel. The field technician also typically isolates and disconnects the defective phase. Other short term corrective measures include the running of temporary services from a lamp post or street light or overhead secondary.

However, a practical time limitation on these types of temporary service restoration is a maximum of ninety days. Also, the use of temporary services from lamp posts or street lights is unsightly and hazardous. Further, bridging the customer's active working phase to the faulted phase may lead to liability issues when working on the customer's equipment. Also, many known temporary bridging schemes or devices render the electrical meter inoperative, thereby affecting proper billing for electricity utilized at that location. It may then take a few weeks or months for the electricity provider to properly fix the problem. Thus, it is desirable for the provider of electricity to properly rectify this problem at the customer's location as soon as possible.

Thus, there remains a need for improvements in bridging adapters. In particular, there remains a need for improvements in providing a bridging adapter that allows for a relatively quick, simple and safe connection between a working electrical phase and an inoperable electrical phase at the location of the electrical meter at the customer's premises until a more permanent fix can be performed by the electricity provider.

### SUMMARY OF THE INVENTION

According to an aspect of the invention, apparatus for connecting an inoperable phase of electricity with an operable phase of electricity includes an electricity meter, a socket, and an electricity meter adapter having at least one first connector for a first phase of electricity and at least one second connector for a second phase of electricity, a bridging adapter connected between the at least one first connector for a first phase of electricity and the at least one second connector for a second phase of electricity thereby connecting together the first and second phases of electricity, wherein the electricity meter adapter is connected with the socket and the electricity meter is connected with the electricity meter adapter.

According to another aspect of the invention, a bridging adapter for connecting an inoperable phase of electricity with an operable phase of electricity to thereby cause the inoperable phase of electricity to become operable, the bridging adapter adapted to be operable in an electricity meter adapter having a first connector for a first phase of electricity and a second connector for a second phase of electricity, the bridging adapter being operable with apparatus that includes an electricity meter; and a socket. The bridging adapter is connected between the first connector for a first phase of electricity and the second connector for a second phase of electricity thereby connecting together the first and second phases of electricity, wherein the electricity meter adapter is connected with the socket and the electricity meter is connected with the electricity meter adapter.

According to yet another aspect of the invention, a method for connecting an inoperable phase of electricity with an operable phase of electricity includes providing an electricity meter, providing a socket, providing an electricity meter adapter having at least one first connector for a first phase of electricity and at least one second connector for a second phase of electricity, and connecting a bridging adapter between the at least one first connector for a first phase of electricity and the at least one second connector for a second phase of electricity thereby connecting together the first and second phases of electricity. The method further includes connecting the electricity meter adapter with the socket and connecting the electricity meter with the electricity meter adapter.

These and other advantages and features will become more apparent from the following description taken in conjunction with the drawings.

### BRIEF DESCRIPTION OF THE DRAWINGS

Referring now to the drawings, which are meant to be exemplary and not limiting, and wherein like elements are numbered alike:

FIG. 1 is a perspective view of an electrical meter adapter having a bridging adapter installed therein in accordance with an embodiment of the invention;

FIG. 2 is a top plan view of the electrical meter adapter of FIG. 1;

FIG. 3 is a side view of the electrical meter adapter of FIG. 1;

FIG. 4 is a bottom view of the electrical meter adapter of FIG. 1; and

FIG. 5 is a perspective view of the electrical meter adapter of FIG. 1 installed with an electrical meter.

### DETAILED DESCRIPTION OF THE INVENTION

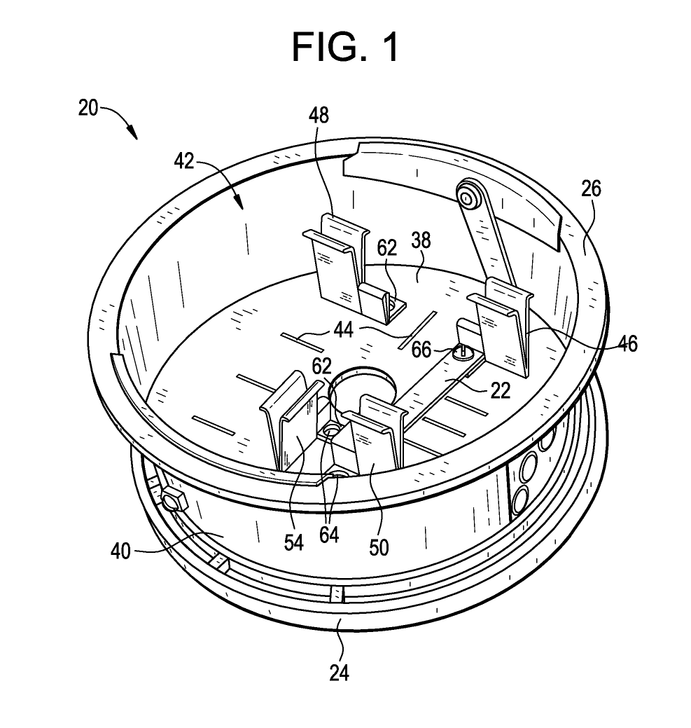

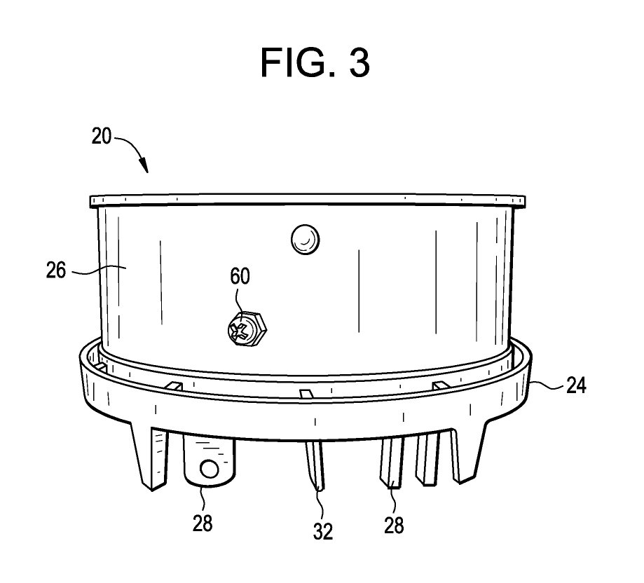

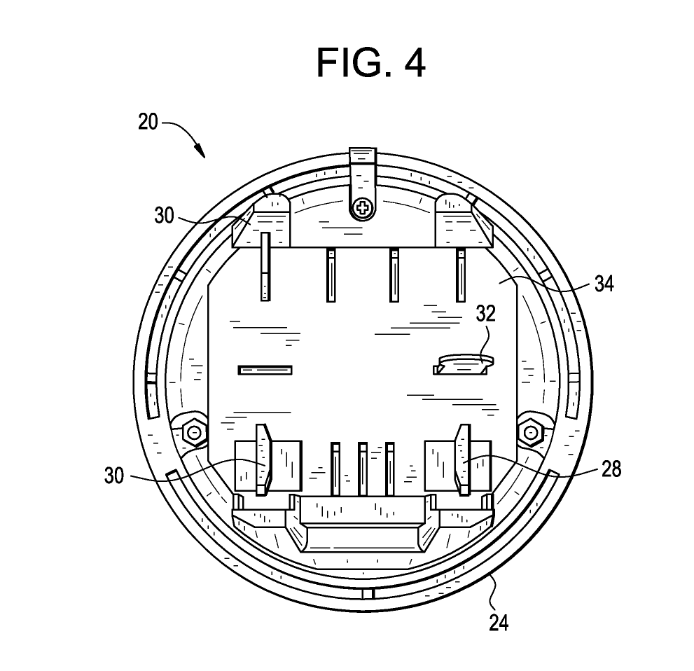

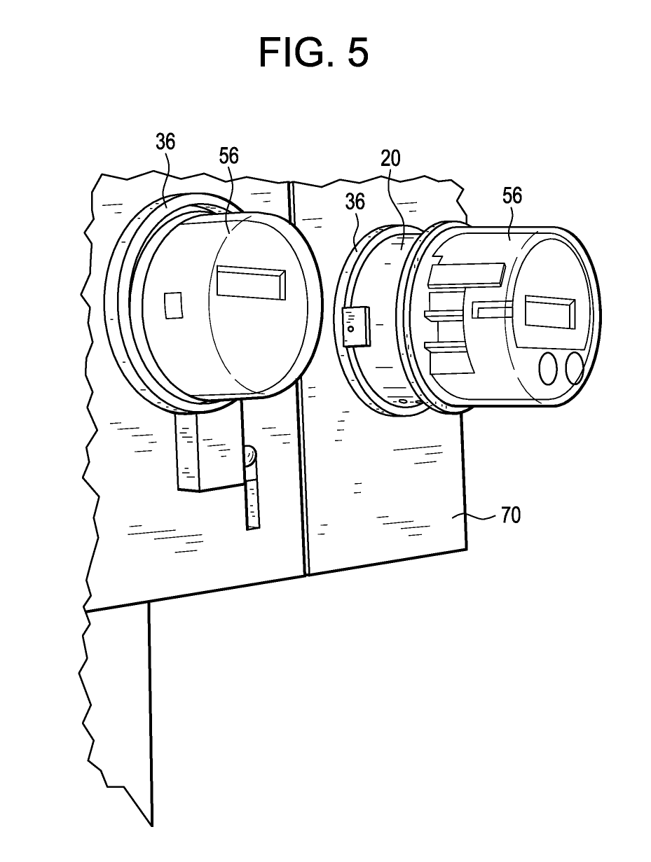

FIGS. 1-4 illustrate an electrical meter adapter 20 having a bridging adapter 22 installed therein according to an embodiment of the present invention for use with the provision of two-phase electricity, typically at a residence location. The meter adapter 20 includes a base 24 coupled to a housing 26. The base 24 includes a single first phase conductor 28, a pair of second phase conductors 30, and a neutral conductor 32. The conductors 28, 30, 32 extend from a bottom surface 34 of the base 24, as best shown in FIG. 3. In the embodiment shown, the base 24 and conductors 28, 30, 32 are generally adapted to interface with a standard electrical meter socket 36 (FIG. 5), such as those used by electrical utilities on residential buildings for example.

The housing 26 includes a generally flat bottom panel 38, and a circular wall 40 extending about its periphery. The panel 38 and wall 40 define an interior portion 42 of the meter adapter 20. A plurality of elongated openings 44 is located in the flat panel 38. The openings 44 allow wires and conductors to pass through. The conductors 28, 30, 32 extend through the openings 44 and into the interior portion 42 of the meter adapter 20. The first phase conductor 28 is coupled to a bayonet stab electrically-conductive connector 50 made from, e.g., copper. The second phase conductors 30 are coupled to similar bayonet stabs 46, 48. The neutral conductor 32 is coupled to a bayonet stab 54 as well. In the embodiment shown, each of the bayonet stabs 46, 48, 50, 54 is adapted to interface with corresponding conductors (not shown) in an electrical meter 56 (FIG. 5). A wire or other suitable conductor 58 electrically connects the neutral bayonet stab 54 to a neutral terminal 60 mounted on an outer surface of the peripheral wall 40.

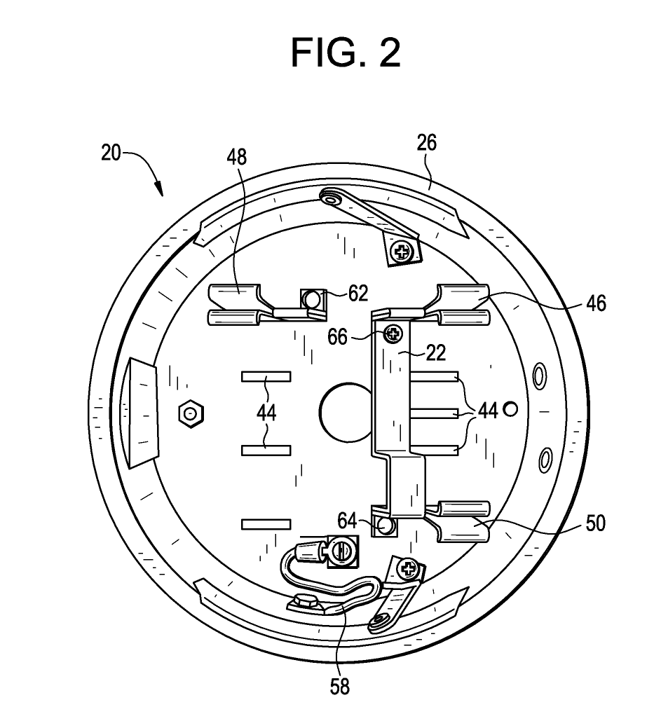

In use, when one of the two phases of electricity provided to the customer at the customer's premises is defective or otherwise inoperable, the electricity provider can utilize the bridging adapter 22 of embodiments of the present invention to provide and relatively, simple, easy and quick solution to the problem until a more permanent solution can be provided. The bridging adapter 22 of embodiments of the present invention is used to connect the inoperable phase to the operable phase. This may be accomplished in embodiments of the present invention through a relatively secure electrical connection of the bridging adapter 22 between the inoperable and operable phases in the electrical meter adapter. As best seen in FIGS. 1 and 2, each of the bayonet stabs 46, 48, 50, 54 includes a portion that is somewhat lower in height than the stab itself. Connected with this portion is flat conductive (e.g., copper) portion 62 that rests or is connected with the flat panel 38. This flat portion 62 has a threaded screw hole 64 formed therein, which allows for the placement of a screw 66 in the threaded screw hole 64.

As seen in FIGS. 1 and 2, the bridging adapter 22 can then be securely connected between the operable electricity phase and the inoperable electricity phase by screwing the adapter in the holes 64 using the screws 66. The bridging adapter 22 may comprise, in an embodiment, a piece of copper that is thick and wide enough to handle the electrical current that flows between the two phases of electricity. Also, as seen in FIGS. 1 and 2, the bridging adapter 22 of an embodiment may be higher on one side (i.e., the side connected with the stab 50) than on the other side (i.e., the side connected with the stab 46). However, other suitable shapes for the bridging adapter 22 are contemplated by embodiments of the present invention.

Then, as seen in FIG. 5, when a field technician or other employee of the electricity provider goes to the customer's premises, that person removes the electrical meter 56 from its socket 36 without entering the building or facility 70 that the electrical meter 56 connects to. The electrical meter adapter 20 with the bridging adapter 22 installed is then inserted into the meter socket 36 and the electrical meter 56 is then installed in the meter adapter 20. This then allows the two phases of electricity to be operable again until a more permanent fix to the problem can be provided by the electricity supplier.

Embodiments of the present invention eliminate the need to utilize a temporary jumper to bridge or connect the phases at the customer's circuit breaker box/service panel or end line service box. Thus, embodiments of the bridging adapter allow for faster service restoration while also improving safety, and also allowing for continued use of the electrical meter, thereby achieving proper billing for electricity utilized.

While the invention has been described with reference to exemplary embodiments, it will be understood that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. Apparatus for connecting an inoperable phase of electricity with an operable phase of electricity, comprising:
an electricity meter;
a socket; and
an electricity meter adapter having at least one first connector for a first phase of electricity and at least one second connector for a second phase of electricity, a bridging adapter connected between the at least one first connector for a first phase of electricity and the at least one second connector for a second phase of electricity thereby connecting together the first and second phases of electricity, wherein the electricity meter adapter is connected with the socket and the electricity meter is connected with the electricity meter adapter.

2. The apparatus of claim 1, wherein one of the first and second phases of electricity is inoperable, and wherein the bridging adapter when connected between the at least one first connector for a first phase of electricity and the at least one second connector for a second phase of electricity causes both the first and second phases of electricity to be operable.

3. The apparatus of claim 1, wherein the bridging adapter comprises an electrically conductive material.

4. The apparatus of claim 3, wherein the electrically conductive material comprises copper.

5. The apparatus of claim 1, wherein the bridging adapter is connected between the at least one first connector for a first phase of electricity and the at least one second connector for a second phase of electricity by a mechanical connection.

6. The apparatus of claim 5, wherein the mechanical connection comprises a screw and threaded hole combination.

7. The apparatus of claim 1, wherein the electricity meter, the socket and the electricity meter adapter are located at premises of a customer of an electricity provider.

8. A bridging adapter for connecting an inoperable phase of electricity with an operable phase of electricity to thereby cause the inoperable phase of electricity to become operable, the bridging adapter adapted to be operable in an electricity meter adapter having a first connector for a first phase of electricity and a second connector for a second phase of electricity, the bridging adapter being operable with apparatus comprising:
an electricity meter; and
a socket;
wherein the bridging adapter is connected between the first connector for a first phase of electricity and the second connector for a second phase of electricity thereby connecting together the first and second phases of electricity, wherein the electricity meter adapter is connected with the socket and the electricity meter is connected with the electricity meter adapter.

9. The bridging adapter of claim 8, wherein the bridging adapter comprises an electrically conductive material.

10. The bridging adapter of claim 9, wherein the electrically conductive material comprises copper.

11. The bridging adapter of claim 8, wherein the bridging adapter is connected between the at least one first connector for a first phase of electricity and the at least one second connector for a second phase of electricity by a mechanical connection.

12. The bridging adapter of claim 11, wherein the mechanical connection comprises a screw and threaded hole combination.

13. The bridging adapter of claim 8, wherein the electricity meter, the socket and the electricity meter adapter are located at premises of a customer of an electricity provider.

14. The bridging adapter of claim 8, wherein the bridging adapter is connected between an extension portion of the first connector for a first phase of electricity and an extension portion for the second connector for a second phase of electricity thereby connecting together the first and second phases of electricity

15. A method for connecting an inoperable phase of electricity with an operable phase of electricity, the method comprising the steps of:
providing an electricity meter;
providing a socket;
providing an electricity meter adapter having at least one first connector for a first phase of electricity and at least one second connector for a second phase of electricity;
connecting a bridging adapter between the at least one first connector for a first phase of electricity and the at least one second connector for a second phase of electricity thereby connecting together the first and second phases of electricity;
connecting the electricity meter adapter with the socket; and
connecting the electricity meter with the electricity meter adapter.

16. The method of claim 15, wherein one of the first and second phases of electricity is inoperable, and wherein the bridging adapter when connected between the at least one first connector for a first phase of electricity and the at least one second connector for a second phase of electricity causes both the first and second phases of electricity to be operable.

17. The method of claim 15, wherein the bridging adapter comprises an electrically conductive material.

18. The method of claim 17, wherein the electrically conductive material comprises copper.

19. The method of claim 15, wherein the step of connecting a bridging adapter between the at least one first connector for a first phase of electricity and the at least one second connector for a second phase of electricity comprises connecting a bridging adapter between the at least one first connector for a first phase of electricity and the at least one second connector for a second phase of electricity by a mechanical connection.

20. The method of claim 15, wherein the electricity meter, the socket and the electricity meter adapter are located at premises of a customer of an electricity provider.
